(19) United States
(12) Patent Application Publication
(10) Pub. No.: US 2019/0321853 A1
(43) Pub. Date: Oct. 24, 2019

(54) ELASTIC LAYER FOR ULTRASONIC TRANSDUCER

(71) Applicant: uBeam Inc., Santa Monica, CA (US)

(72) Inventors: Iman Shahosseini, Woodland Hills, CA (US); Zuki Tanaka, Culver City, CA (US)

(21) Appl. No.: 15/961,152

(22) Filed: Apr. 24, 2018

(51) Int. Cl. B06B 1/06; G10K 13/00

(52) U.S. Cl. CPC B06B 1/067; G10K 13/00; B06B 1/0666

(57) ABSTRACT

An apparatus of the disclosure is directed to an elongated polygon transducer membrane having a perimeter that includes a plurality of edges and a plurality of vertices. The elongated polygon transducer membrane may be fixed to a support structure at or around a plurality of the vertices and not fixed to the support structure at more than 50% of the perimeter. The apparatus of the disclosure may be an elongated hexagon transducer membrane having a perimeter comprising six edges and six vertices. The elongated hexagon transducer membrane may be fixed to a support structure at or around two vertices of the six vertices that are most distant from each other and not fixed at the other vertices or the edges of the perimeter.

### BACKGROUND

Ultrasonic transducers receive acoustic energy at ultrasonic frequencies as an input and provide electrical energy as an output, or receive electrical energy as an input and provide acoustic energy at ultrasonic frequencies as an output. An ultrasonic transducer can include a piece of piezoelectric material that changes size in response to the application of an electric field. If the electric field is made to change at a rate comparable to ultrasonic frequencies, then the piezoelectric element can vibrate and generate acoustic pressure waves at ultrasonic frequencies. Likewise, when the piezoelectric element resonates in response to impinging ultrasonic energy, the element can generate electrical energy.

### BRIEF SUMMARY

Implementations of the disclosed subject matter provide an apparatus that includes an elongated polygon transducer membrane having a perimeter that includes a plurality of edges and a plurality of vertices. The elongated polygon transducer membrane may be fixed to a support structure at or around a plurality of the vertices and not fixed to the support structure at more than 50% of the perimeter. A conical structure may be coupled to the elongated polygon transducer membrane that may have a lower profile and larger opening angle than typical structures that may be coupled to a transducer.

Implementations of the disclosed subject matter provide an apparatus that includes an elongated hexagon transducer membrane having a perimeter comprising six edges and six vertices. The elongated hexagon transducer membrane may be fixed to a support structure at or around two vertices of the six vertices that are most distant from each other and not fixed at the other vertices or the edges of the perimeter. A conical structure may be coupled to the elongated hexagon transducer membrane.

Additional features, advantages, and embodiments of the disclosed subject matter may be set forth or apparent from consideration of the following detailed description, drawings, and claims. Moreover, it is to be understood that both the foregoing summary and the following detailed description are examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1A shows an example of a conical structure coupled to an elongated polygon transducer membrane of an ultrasonic transducer according to an implementation of the disclosed subject matter.

FIG. 1B shows a bottom view of an example ultrasonic transducer according to an implementation of the disclosed subject matter.

FIGS. 2A-2B show a conical structure coupled to an elongated polygon-shaped electrically active material layer according implementations of the disclosed subject matter.

FIG. 3 shows a top view of an example elongated polygon transducer membrane of an ultrasonic transducer according to an implementation of the disclosed subject matter.

FIGS. 4A-4E show views of example attachment points disposed on elongated polygon transducer membrane of an ultrasonic transducer according to implementations of the disclosed subject matter.

FIG. 5 shows a top view of an example elongated polygon transducer membrane of an ultrasonic transducer according to an implementation of the disclosed subject matter.

FIGS. 6A-6H show examples of ribs or patterns disposed on a surface of the elongated polygon transducer membrane according to implementations of the disclosed subject matter.

FIG. 7 shows an example of radial members extending from a center pattern disposed on a surface of the elongated polygon transducer membrane according to an implementation of the disclosed subject matter.

FIGS. 8A-8G show example cross-sectional views of rib profiles according to implementations of the disclosed subject matter.

FIG. 9 shows an electrically conductive member coupled to one of the vertices of an elongated hexagon transducer membrane according to an implementation of the disclosed subject matter.

FIG. 10 shows an example of a transducer array according to an implementation of the disclosed subject matter.

### DETAILED DESCRIPTION

Implementations of the disclosed subject matter provide a conical structure coupled to an ultrasonic transducer. The transducer may include an elongated polygon transducer membrane having a perimeter with a plurality of edges and a plurality of vertices. The elongated polygon transducer membrane may be fixed to a support structure at or around a plurality of the vertices and not fixed to the support structure at more than 50% of the perimeter. The elongated polygon transducer membrane may be elongated such that has at least two of the edges have a greater length than that of the other edges of the plurality of edges. In some implementations, at least one rib or pattern may be disposed on a surface of the elongated polygon transducer membrane to minimize the transducer mass while keeping the same structural stiffness to increase the power efficiency of the transducer.

In implementations of the disclosed subject matter, the elongated polygon transducer membrane may be an elongated hexagon transducer membrane having a perimeter comprising six edges and six vertices. The elongated hexagon transducer membrane may be fixed to a support structure at or around two vertices of the six vertices that are most distant from each other and not fixed at the other vertices or the edges of the perimeter.

Implementations of the disclosed subject matter provide a conical structure and a transducer that includes elongated polygon transducer membrane to increase acoustic pressure of a transmitted ultrasonic wave and/or maximize the signal-to-noise ratio of a received ultrasonic signal, so that an electric signal with decreased noise may be obtained by a receiving device for processing. That is, implementations of the disclosed subject matter provide a transducer having an elongated polygon transducer membrane to generate maximum power from input signals. The transducer having the elongated polygon transducer membrane may generate a useable signal (even from received low-amplitude signals), regardless of the signal-to-noise ratio of the received signal. In the apparatus of the disclosed subject matter, the stiffness of the elongated polygon transducer membrane of the transducer may be adjusted to tune the working frequency (e.g., to increase the amount of energy harvested) and to provide acoustic matching between the operating medium (e.g., air) and the transducer.

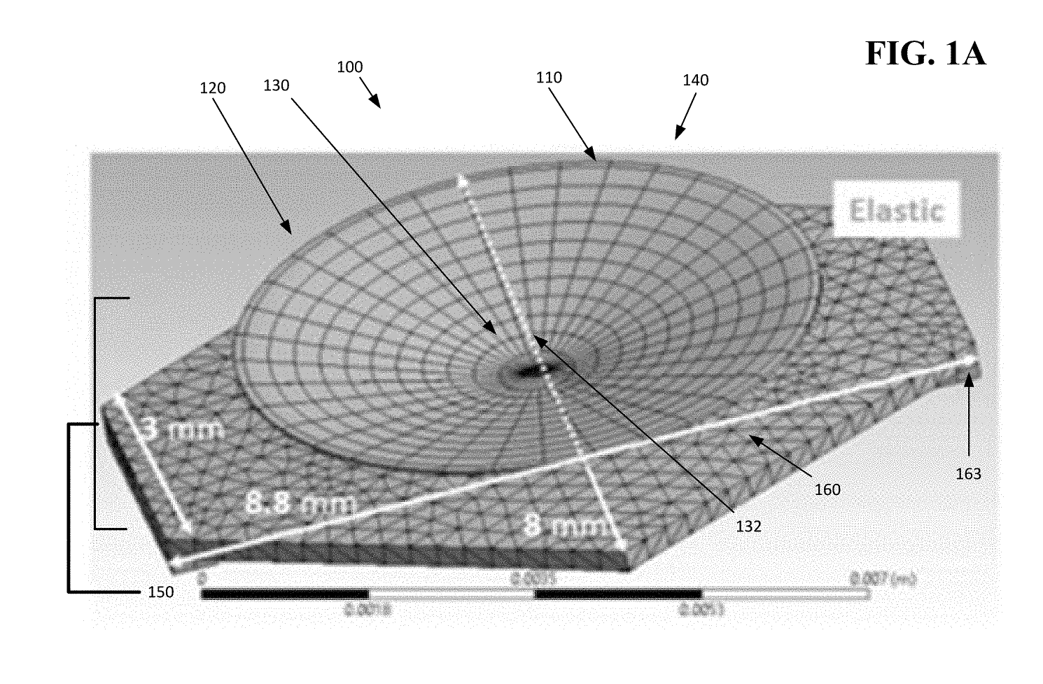

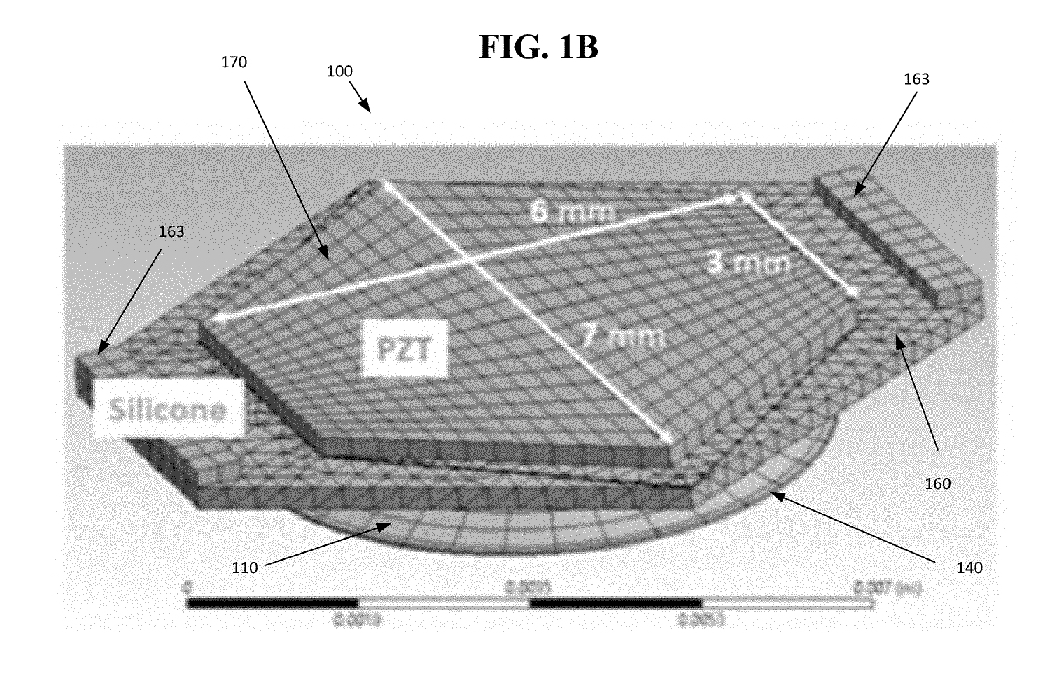

FIG. 1A shows an example of a conical structure coupled to an ultrasonic transducer according to an implementation of the disclosed subject matter. An apparatus 100 may include a conical structure 110 that has a first circumference 120 and a second circumference 130, that are respectively located at opposite ends of the conical structure 110. The conical structure 110 may be formed from steel, stainless steel, aluminum, plastic, carbon fiber composite, or any other suitable material. The conical structure 110 may be formed through any suitable additive or subtractive processes. In some implementations, a rim 140 may be coupled at or adjacent to the first circumference 120 of the conical structure 110. That is, the surface area of the conical structure 110 may be adjusted by adding the rim 140 to a portion of the conical structure 140. The surface area of the conical structure 110 may be adjusted by varying the angle between the first and second circumferences 120, 130 of the conical structure 110, as well as the height and/or the width of the rim 140 attached to the conical structure 110. These features of the conical structure 110 may be adjusted so as to maximize the surface area to capture as much of an incident ultrasonic wave as possible and generate a useable signal. The rim 140 may be formed structurally with the conical structure 110 through the additive or subtractive process. In some implementations, the rim 140 may be formed separately, and then welded, soldered, affixed (e.g., using an adhesive), and/or coupled in any suitable manner to the conical structure 110. The type of coupling used may be selected based on, for example, the type of material used to form the conical structure 110 and/or the rim 140.

In some implementations, at least one of the circumferences 120, 130 that defines an opening of the conical structure 110 may be adjusted from a circle shape to an oval shape so as to adjust the focus of the conical structure 110 for a transmitted signal or a received ultrasonic signal. In some implementations, at least one of the circumferences 120, 130 that defines an opening of the conical structure 110 may be adjusted to have a polygon shape. The sidewalls disposed between the circumferences that define the openings of the conical structure may be formed in a planar shape, a convex shape, or a concave shape to adjust the focus of the conical structure for a transmitted signal or a received ultrasonic signal.

The first circumference 120 and the second circumference 130 may be any suitable length. In some implementations, the first circumference of the conical structure 110 may have a length that is 5-10 mm, 10-15 mm, 15-20 mm, 20-25 mm, or 25-30 mm. In some implementations, the first circumference of the conical structure 110 may have a length that is 15-25 mm. The second circumference of the conical structure 110 may have length that is 1-2 mm, 2-3 mm, 3-4 mm, or 4-5 mm. In some implementations, the second circumference of the conical structure 110 may have length that is 2-4 mm.

In some implementations, the first circumference 120 and the second circumference 130 may each form openings respectively located at opposite ends of the conical structure 110. In some implementations, a second opening may be formed in at least a portion of the area of the second circumference 130 to form a hole. In some implementations, a covering may be formed over the opening formed by the second circumference 130.

The rim 140 of the conical structure 110 shown in FIG. 1A may have a height of 10-30 μm, 30-50 μm, 50-70 μm, 70-90 μm, 90-110 μm, 110-130 μm, 130-150 μm, 150-170 μm, 170-190 μm, or 190-210 μm, or any other suitable height. In some implementations, the height of the rim 140 may be 50-110 μm. The height of the rim 140 may be the same as the thickness of the conical structure 110. The thickness of the conical structure 110 may be 10-30 μm, 30-50 m, 50-70 μm, 70-90 μm, 90-110 μm, 110-130 μm, 130-150 μm, 150-170 μm, 170-190 μm, or 190-210 μm, or any other suitable thickness. In some implementations, the thickness of the rim 140 may be 50-110 m. A width of the rim 140 may be 0-0.1 mm, 0.1 mm-0.2 mm, 0.2-0.4 mm, and 0.4-0.5 mm, 0.5-0.6 mm, 0.6-0.7 mm, 0.7 mm-0.8 mm, or 0.9-1.0 mm, or any other suitable width. In some implementations, the width of the rim 140 may be 0.01-0.2 mm. The width of the rim may be a distance from an inner rim circumference to an outer rim circumference. An inner rim circumference may correspond to that of the first circumference 120 of the conical structure 110.

A distance between the first circumference 120 and the second circumference 130 may be 0.1-0.3 mm, 0.3-0.7 mm, 0.7-1.1 mm, or 1.1-1.5 mm. In some implementations, the distance may be 0.7-1.2 mm. The first circumference 120 may have a greater length than the second circumference 130. An angle between the second circumference 130 and the first circumference 120 may be between a plane including the second circumference 130 and a surface of the conical structure 110, and, in some implementations, may variably increase. In implementations of the disclosed subject matter, the angle may be 150°-170°, or any other suitable angle. This angle of the conical structure 110 may maximize the surface area to capture as much of an incident ultrasonic wave as possible and generate a useable signal.

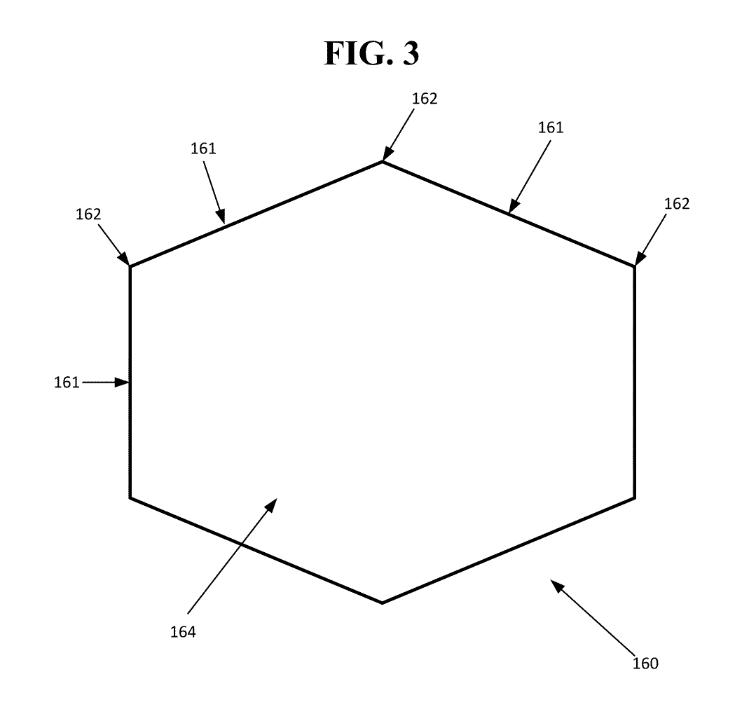

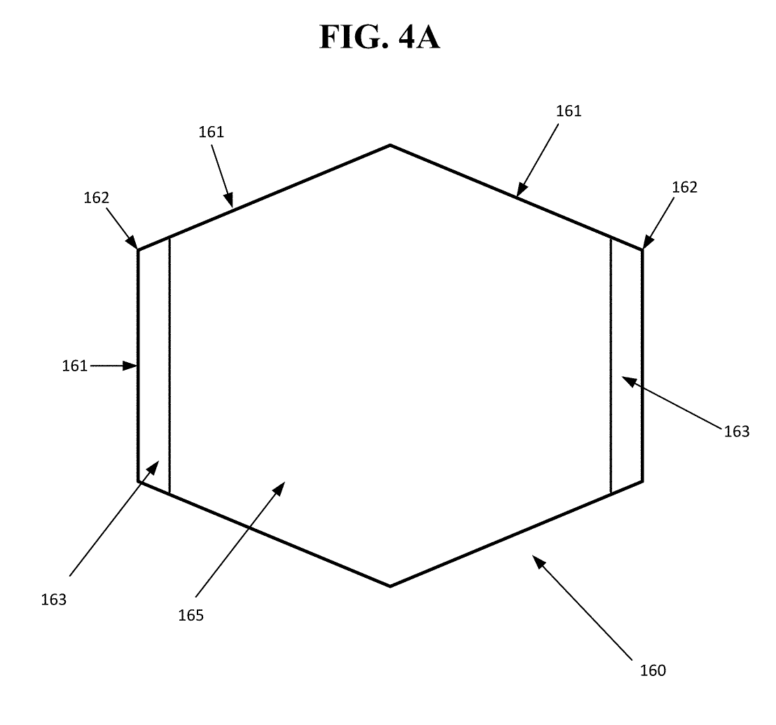

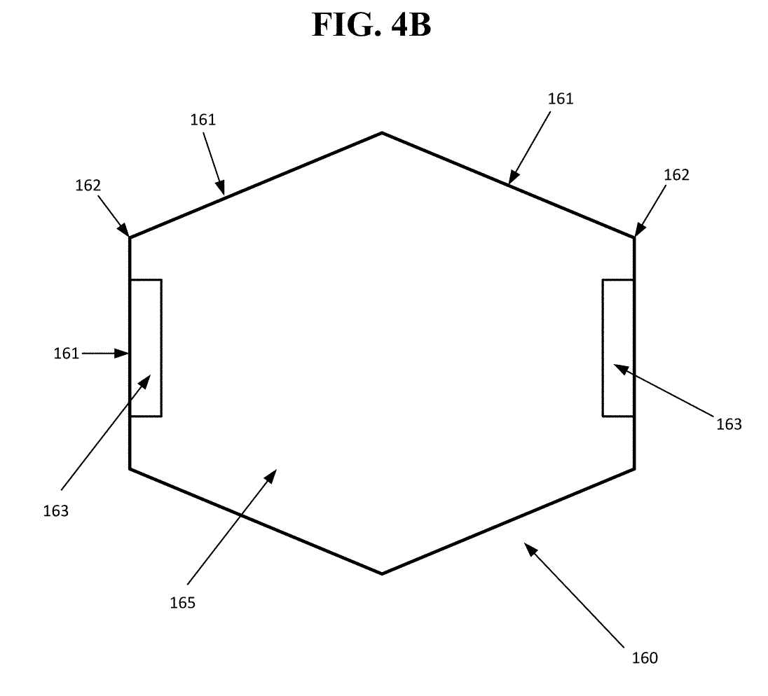

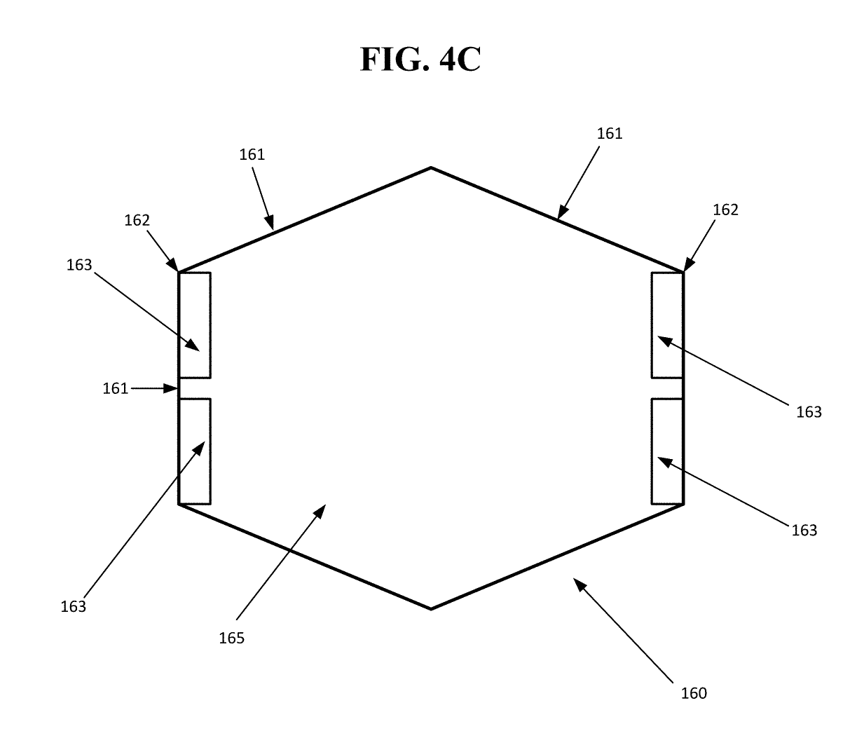

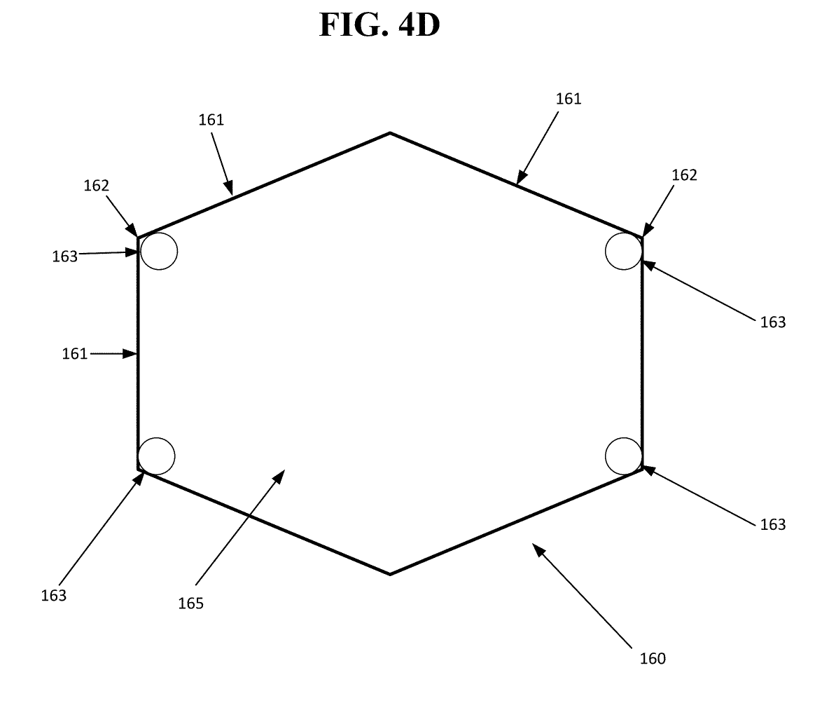

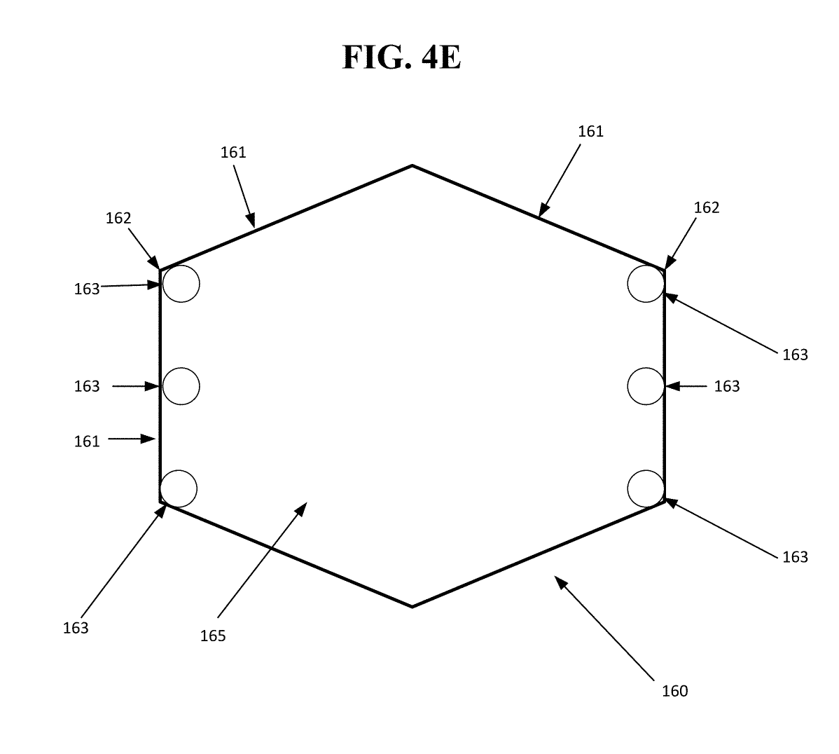

The second circumference 130 of the conical structure 110 may be coupled an ultrasonic transducer 150, which may include an elongated polygon transducer membrane 160 and elongated polygon-shaped electrically active material layer 170, as shown in FIG. 1B. Attachment points 163 (e.g., silicone or the like) may be disposed on a bottom surface (e.g., surface 165 shown in FIG. 4A) of the elongated polygon transducer membrane 160 (as shown in FIG. 1B), and may be used to attach transducer 150 to a base or other support structure. In some implementations, the attachment points 163 may be disposed on a top surface (e.g., surface 164 shown in FIG. 3) of the elongated polygon transducer membrane 160. In some implementations, the elongated polygon transducer membrane 160 may be an elongated hexagon transducer membrane having a perimeter comprising six edges and six vertices. The elongated hexagon transducer membrane may be fixed to a support structure (e.g., at attachment points 163, as shown in FIGS. 4A-4E) at or around two vertices of the six vertices that are most distant from each other and not fixed at the other vertices or the edges of the perimeter. By attaching the elongated polygon transducer membrane 160 at the attachment points 163 shown in FIGS. 4A-4E, the efficiency of the ultrasonic transducer 150 may be increased by two or three times over an arrangement where the elongated polygon transducer membrane 160 is attached more around the perimeter. Increased deflection of the ultrasonic transducer 150 may occur, and the arrangement may provide increased acoustic matching between the operating medium (e.g., air) and the transducer. That is, by using the arrangement shown in FIGS. 4A-4E, the ultrasonic transducer 150 may increase acoustic pressure of a transmitted ultrasonic wave and/or maximize the signal-to-noise ratio of a received ultrasonic signal so that the ultrasonic transducer 150 may generate maximum power from input signals.

The ultrasonic transducer 150 may be coupled to the conical structure 110 by applying an adhesive, bonding, welding, or soldering, and/or may be coupled in any other suitable manner. The type of coupling used may be selected based on, for example, the type of material used to form the conical structure 110. The elongated polygon-shaped electrically active material layer 170 may be disposed on the elongated polygon-shaped transducer elastic layer 160 to transform electrical excitation into a high-frequency vibration to produce ultrasonic acoustic emissions or transform received high-frequency acoustic vibration into electrical signals.

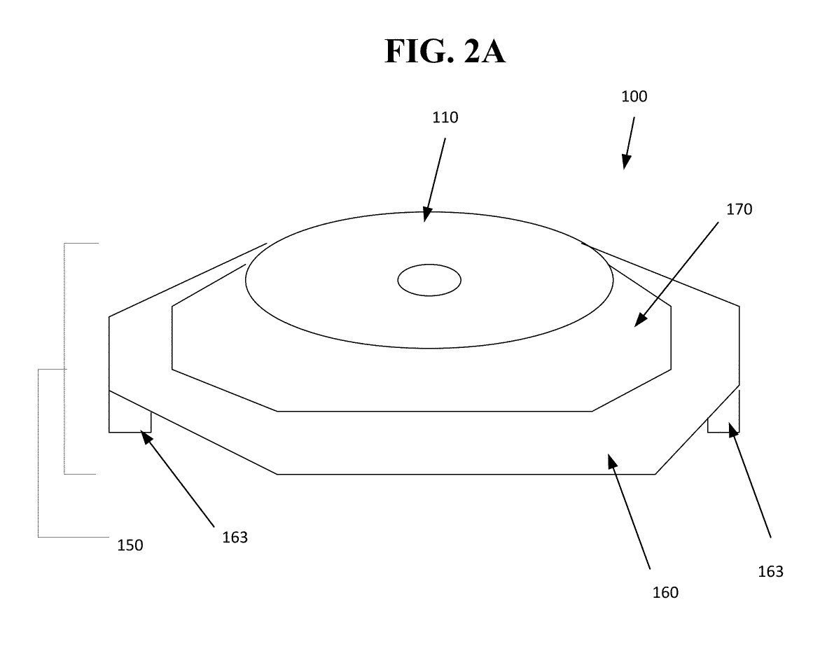

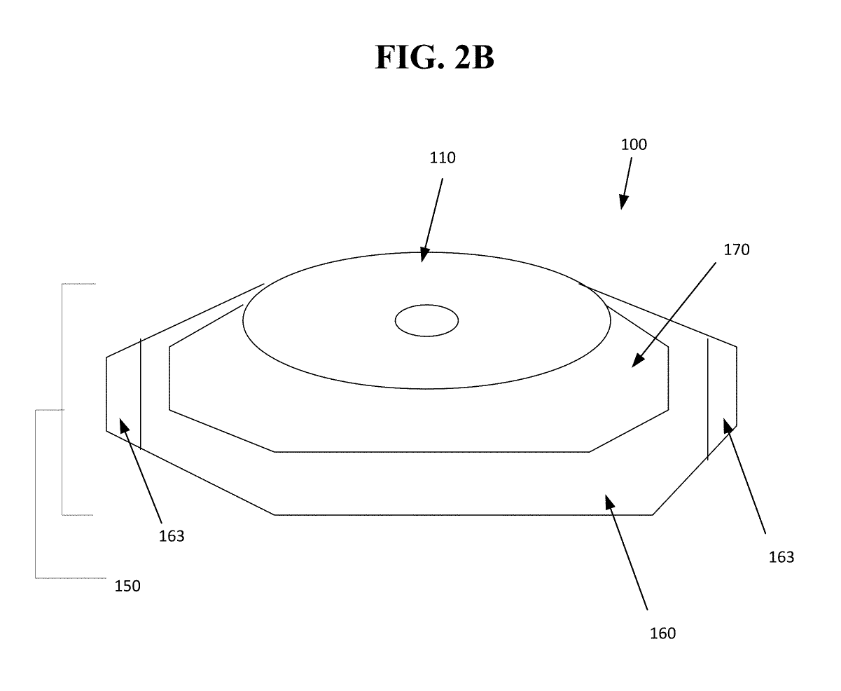

FIGS. 1A-1B show the conical structure 110 coupled to the elongated polygon transducer membrane 160, with elongated polygon-shaped electrically active material layer 170 disposed on the bottom of the elongated polygon transducer membrane 160 according to implementations of the disclosed subject matter. In some implementations, such as shown in FIGS. 2A-2B, the conical structure 110 may be coupled to the elongated polygon-shaped electrically active material layer 170, and the elongated polygon transducer membrane 160 may be disposed on the bottom of the elongated polygon-shaped electrically active material layer 170. In FIG. 2A, the attachment points 163 may be disposed on a bottom surface of the elongated polygon transducer membrane 160, and may be used to attach transducer 150 to a base or support structure. In some implementations, as shown in FIG. 2B, the attachment points 163 may be disposed on a top surface of the elongated polygon transducer membrane 160.

The ultrasonic transducer 150, shown in FIGS. 1A-2B, may receive an electrical control signal (a “driving signal”), causing the elongated polygon-shaped electrically active material layer 170 (e.g., a flexure to bend and/or the tip) to vibrate relative to its base at or around ultrasonic frequencies. The elongated polygon-shaped electrically active material layer 170 can be in direct or indirect communication with the elongated polygon transducer membrane 160, and can cause the elongated polygon transducer membrane 160 to vibrate and create ultrasonic frequency acoustic waves.

The ultrasonic transducer 150 may include an electromechanically active device, such as the elongated polygon-shaped electrically active material layer 170. The elongated polygon-shaped electrically active material layer 170 may be a cantilever or flexure, and may be, for example, a piezoceramic unimorph, bimorph, or trimorph. The elongated polygon-shaped electrically active material layer 170 may include an electrically active material, such as piezoelectric material or piezo-ceramic, electrostrictive material, or ferroelectric material, which may able to transform electrical excitation into a high-frequency vibration to produce ultrasonic acoustic emissions. The geometry of an elongated polygon-shaped electrically active material layer 170 may affect the frequency, velocity, force, displacement, capacitance, bandwidth, and efficiency of electromechanical energy conversion produced by the electromechanically active device when driven to output ultrasound and the voltage and current generated by the elongated polygon-shaped electrically active material layer 170 and efficiency of electromechanical energy conversion when driven by received ultrasound. The elongated polygon-shaped electrically active material layer 170 may have a hexagonal profile, or may have a profile based on any other suitable geometry. The geometry of the elongated polygon-shaped electrically active material layer 170 may be selected, for example, to tune the balance and other various characteristics of the elongated polygon-shaped electrically active material layer 170. The elongated polygon-shaped electrically active material layer 170 may be made using single layer of piezoelectric material laminated onto a single passive substrate material. The elongated polygon-shaped electrically active material layer 170 may also be made with a single piezoelectric layer and multiple passive layers; two piezoelectric layers operating anti-phase or in-phase, or two piezoelectric layers, operating anti-phase or in-phase and combined with one or more electrically passive materials. Different layers of the elongated polygon-shaped electrically active material layer 170 may have different shapes. For example, in a unimorph, a piezoelectric material may be shaped differently from a passive substrate material to which the piezoelectric material is bonded. The piezoelectric material, for example, piezoceramic, used in the electromechanically active device may be poled in any suitable manner, with polarization in any suitable direction.

In some implementations the polarization direction may be along the thickness of the piezoelectric material (e.g., elongated polygon-shaped electrically active material layer 170). The polarization defines the direction along which the electric field is created in the piezoelectric material once a voltage is applied. The operation mode of the piezoelectric material may be based on how the piezoelectric material is integrated into and/or clamped to a structure. The piezoelectric material may be polarized in the direction of its thickness. As one of the surfaces of the piezoelectric material is polarized along its thickness, and because on one side of the piezoelectric material is attached to the elongated polygon transducer membrane 160, by applying the voltage across the top and bottom side of the piezoelectric material, it deforms and bends up and down (e.g., from a concave shape to a convex shape, and vice-versa).

The elongated polygon-shaped electrically active material layer 170 may be any suitable size for use in the ultrasonic transducer 150, and for vibrating at ultrasonic frequencies. The elongated polygon-shaped electrically active material layer 170 may be made in any suitable manner, such as, for example, by cutting polygon-shaped geometries from a larger laminate material. The laminate material may be made from, for example, an electrically active material, such a piezoceramic, bonded to an electrically inactive substrate, such as, for example, metals such as aluminum, Invar, Kovar, silicon/aluminum alloys, stainless steel, and brass, using any suitable bonding techniques and materials. The materials used may be non-optimal for the performance of an individual electromechanically active device. For example, materials may be selected for consistent performance across a larger number of electromechanically active device or for ease of manufacture.

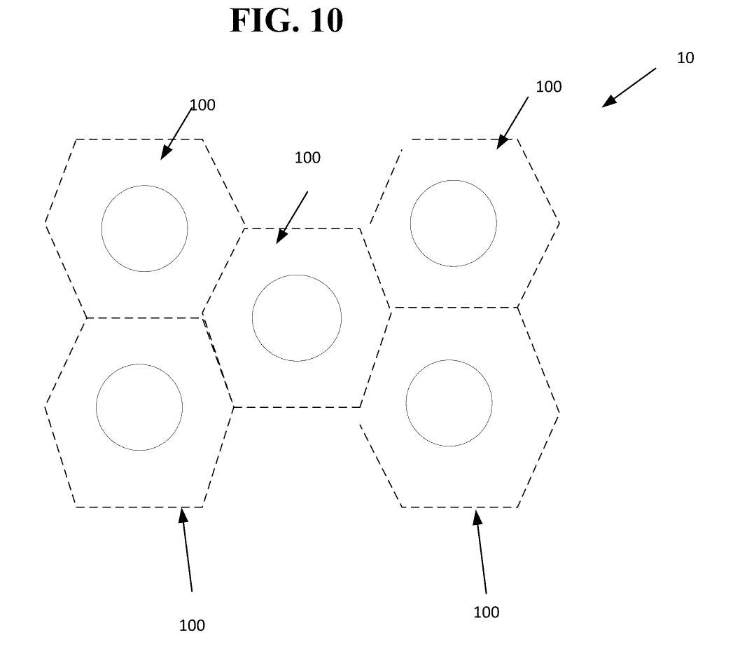

The elongated polygon-shaped electrically active material layer 170 may be oriented at any suitable angle. The top surface of the elongated polygon-shaped electrically active material layer 170, which may be, for example, a passive material of a unimorph or an active material of a bimorph. The elongated polygon-shaped electrically active material layer 170 may be attached to the elongated polygon transducer membrane 160 of an ultrasonic transducer 150 in any suitable manner. For example, any sides of the elongated polygon-shaped electrically active material layer 170 may be bonded to the elongated polygon transducer membrane 160. The bonds used to secure the elongated polygon-shaped electrically active material layer 170 to the elongated polygon transducer membrane 160 may be any suitable combination of organic or inorganic bonds, using any suitable conductive and non-conductive bonding materials, such as, for example, epoxies or solders. The area of contact between the elongated polygon-shaped electrically active material layer 170 and the elongated polygon transducer membrane 160 may be any suitable size and shape. In some implementations, an ultrasonic transducer 150 may include more than one elongated polygon-shaped electrically active material layer 170. As shown in FIG. 10 as disclosed below, any number of ultrasonic transducers may be formed in any suitable arrangement.

The elongated polygon-shaped electrically active material layer 170 may be bonded in a suitable position, with the passive or active layers of the elongated polygon-shaped electrically active material layer 170 facing down depending on whether the electromechanically active device is a unimorph, bimorph, trimorph, or has some other structure. The bond may use any suitable bonding agent, solder, or epoxy. For example, conductive adhesive film may be applied to the areas of the electromechanically active device to be bonded to the elongated polygon transducer membrane 160.

The elongated polygon transducer membrane 160 may be bonded to the ultrasonic transducer 150 to create an ultrasonic device with a membrane. The elongated polygon transducer membrane 160 may be attached with adhesive in a manner that may define the outline of a number of cells of the electromechanical transducer array which the elongated polygon transducer membrane 160 will cover. The elongated polygon-shaped electrically active material layer 170 may be bonded to the elongated polygon transducer membrane 160, for example, at or near the tip of the electromechanically active device. The elongated polygon transducer membrane 160 may be multiple separate pieces of material. The elongated polygon transducer membrane 160 may act to acoustically couple the motion of cantilevers to the air, as the motion of cantilevers may cause the membrane to move.

The elongated polygon transducer membrane 160 may be any suitable material or composite material structure, which may be of any suitable stiffness and weight, for vibrating at ultrasonic frequencies. For example, the elongated polygon transducer membrane 160 may be both stiff and light. For example, the elongated polygon transducer membrane 160 may be aluminum shim stock, metal-patterned Kapton, or any other metal-pattern film. The membrane may be impedance matched with the air to allow for more efficient air-coupling of the ultrasonic transducers.

FIG. 3 shows a top view of an example elongated polygon transducer membrane 160 of an ultrasonic transducer 150 according to an implementation of the disclosed subject matter. The elongated polygon transducer membrane 160 may include edges 161 and vertices 162, where each of the vertices 162 is disposed at the intersection between the edges 161. The elongated polygon transducer membrane 160 may have a first surface 164. The elongated polygon transducer membrane 160 may be formed by any additive or subtractive process from aluminum, monocrystalline silicon, amorphous silicon, brass, Invar, titanium, nickel, steel, iron, magnesium, copper, and/or any other suitable material.

FIGS. 4A-4E show views of example attachment points on the elongated polygon transducer membrane 160 of an ultrasonic transducer 150 according to implementations of the disclosed subject matter. The elongated polygon transducer membrane 160 may be coupled to a support structure at the attachment points 163, which may be formed from silicone or the like. The elongated polygon transducer membrane 160 may fixed to the support structure at the attachment points 163 at or around a plurality of the vertices 162 and not fixed to the support structure at more than 50% of the perimeter that may include the edges 161. FIGS. 4A-4E show different arrangements of the attachment points 163 where the elongated hexagon transducer membrane 160 may be fixed to the support structure.

The elongated polygon transducer membrane 160 may have the first surface 164 shown in FIG. 3, and may have a second surface 165 as shown in FIGS. 4A-4E. In implementations of the disclosed subject matter, at least one of the first surface 164 or the second surface 165 may be coated at least in part with an electrically conductive material. The electrically conductive material may be gold, copper, aluminum, or any other suitable conductive material.

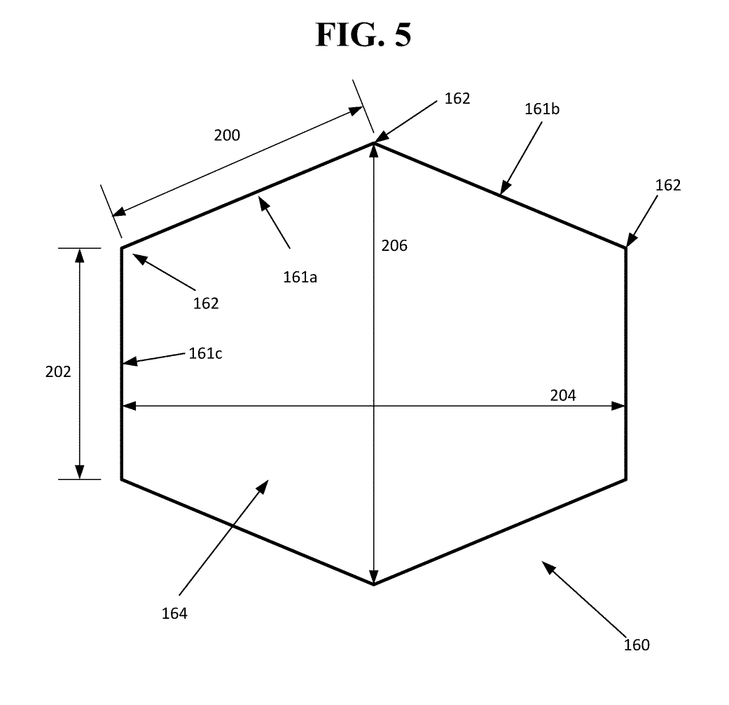

FIG. 5 shows a top view of an example elongated polygon transducer membrane 160 of an ultrasonic transducer 150 according to an implementation of the disclosed subject matter. The elongated polygon transducer membrane 160 may be elongated such that has at least two of the edges (e.g., edges 161a, 161b) have a greater length than that of the other edges (e.g., edge 161c) of the plurality of edges. The elongated polygon transducer membrane 160 may have an aspect ratio, which may be the ratio of the longest dimension to the shortest dimension of the elongated polygon transducer membrane 160. For example, the aspect ratio may be the ratio of dimension 200 to dimension 202. In another example, the aspect ratio may be the ratio of the dimension 204 to dimension 206. In some implementations of the disclosed subject matter, the aspect ratio may be 1.03:1-2:1, 2:1-3:1, 3:1-4:1, 4:1-5:1, or any other suitable aspect ratio. For example, the ratio range 2:1-3:1 may include aspect ratios of such elongated polygon transducer membrane 160 as 2.5:1. In some implementations, the aspect ratio may be 1.03:1-2:1.

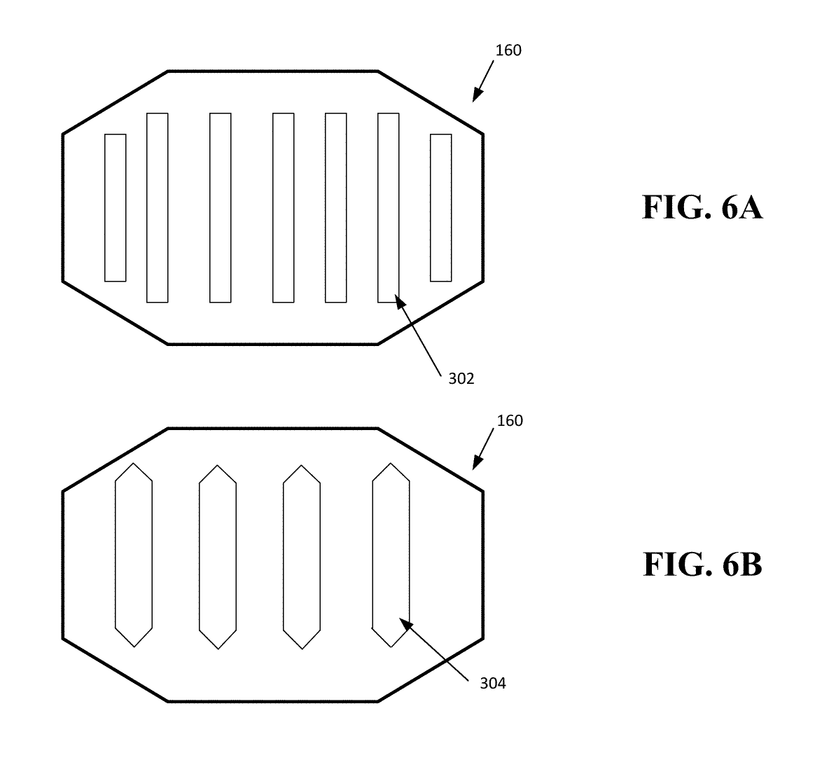

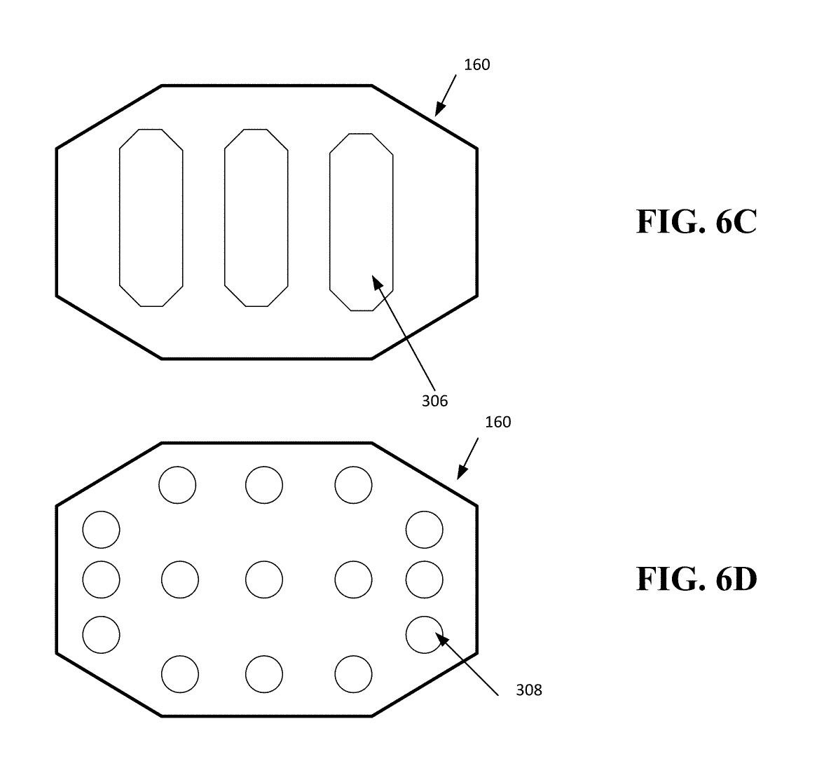

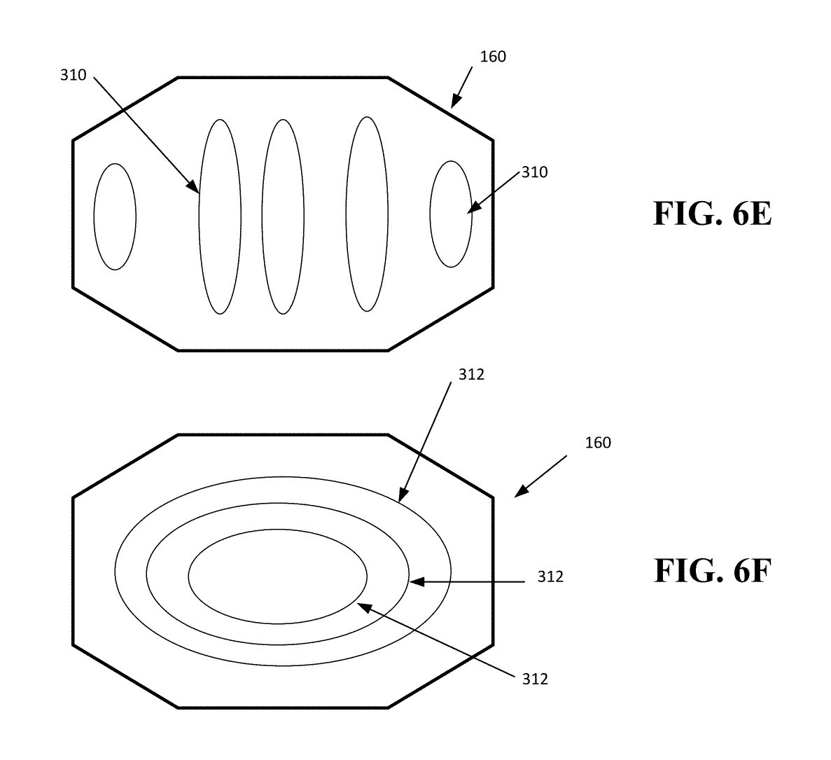

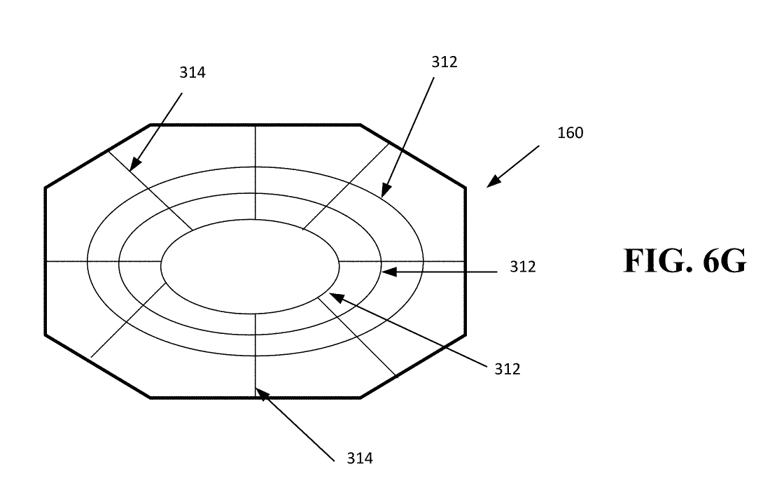

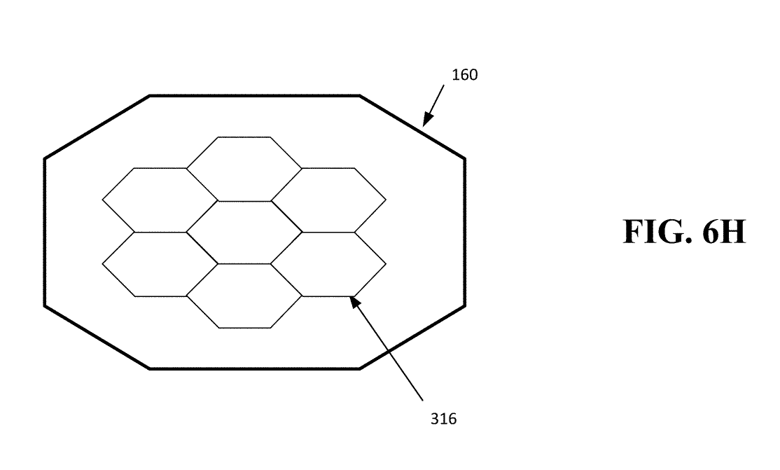

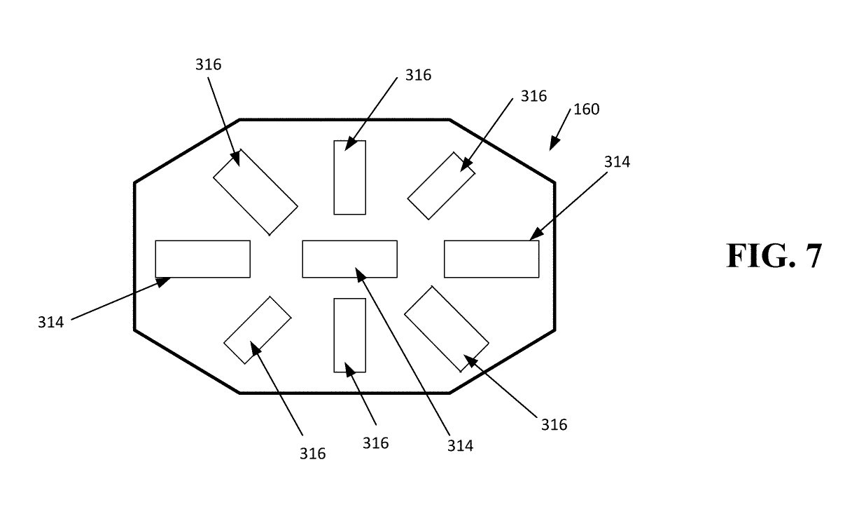

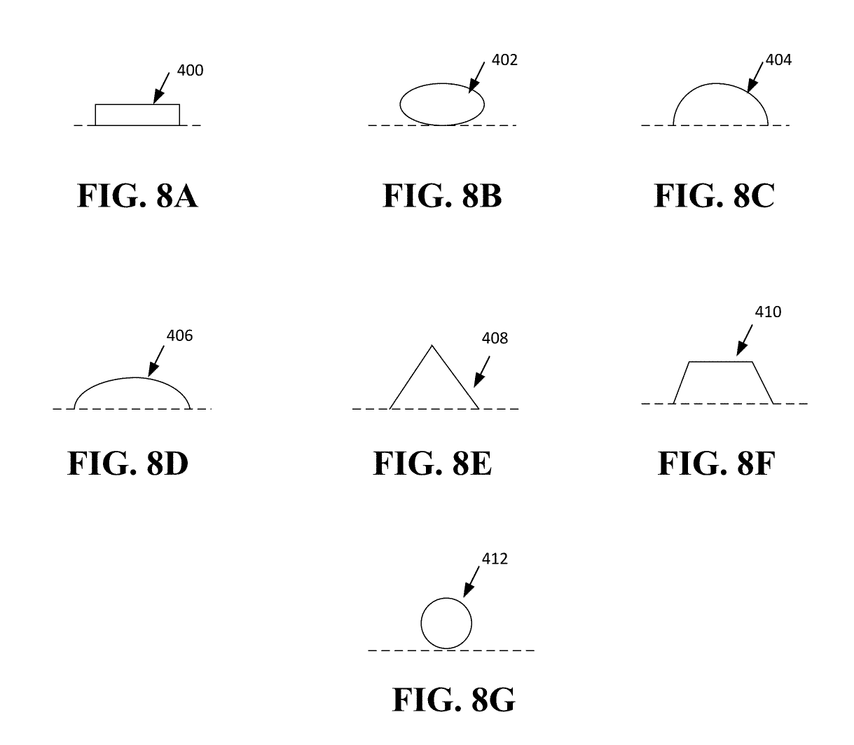

FIGS. 6A-6H show examples of ribs or patterns disposed on a surface of the elongated polygon transducer membrane 160 according to implementations of the disclosed subject matter. The ribs or patterns may be disposed on the surface of the elongated polygon transducer membrane so as to be staggered, where each shape of the rib or the pattern is spaced a predetermined distance away from the adjacent shape in the rib or pattern. The ribs or patterns may be formed through any suitable additive or subtractive processes. The ribs or patterns may be etched into the elongated polygon transducer membrane 160. In some implementations, the rib or pattern may be molded or coupled to the elongated polygon transducer membrane 160. The ribs or patterns may be bonded, welded, soldered, fixed (e.g., with an adhesive), or coupled in any suitable manner to the elongated polygon transducer membrane 160. In some implementations, the ribs or patterns may be integrally formed with the elongated polygon transducer membrane 160 through any suitable additive or subtractive processes. The ribs or patterns (such as those shown in FIGS. 6A-6H, as well as those shown in FIGS. 7-8G) may have a thickness, profile, structure, and/or placement so as to increase the rigidity of the elongated polygon transducer membrane 160. That is, ribs or patterns may be used to tune the stiffness and/or rigidity of the elongated polygon transducer membrane 160, so as to improve the acoustic output power for a transmitted signal or signal-to-noise ratio for a received signal. The selection of ribs or patterns may be used to adjust the weight of the elongated polygon transducer membrane 160 adjusted to minimize a damping effect, which may interfere with generating a useable signal.

FIG. 6A shows a rectangular pattern 302 that may be etched on to the elongated polygon transducer membrane 160, or that may be molded or coupled to the elongated polygon transducer membrane 160. Although FIG. 6A shows that the rectangular pattern 302 may be disposed in a vertical direction on the elongated polygon transducer membrane 160, the rectangular pattern 302 may be alternatively disposed in a horizontal direction on the elongated polygon transducer membrane 160, or in both horizontal and vertical directions.

FIG. 6B shows a hexagonal pattern 304 that may be etched on to the elongated polygon transducer membrane 160, or that may be molded or coupled to the elongated polygon transducer membrane 160. Although FIG. 6B shows that the hexagonal pattern 304 may be disposed in a vertical direction on the elongated polygon transducer membrane 160, the hexagonal pattern 304 may be alternatively disposed in a horizontal direction on the elongated polygon transducer membrane 160.

FIG. 6C shows a polygon pattern 306 that may be etched on to the elongated polygon transducer membrane 160, or that may be molded or coupled to the elongated polygon transducer membrane 160. FIG. 6C shows that the polygon pattern 306 may be disposed in a vertical direction on the elongated polygon transducer membrane 160. Alternatively, the polygon pattern 306 may be alternatively disposed in a horizontal direction on the elongated polygon transducer membrane 160.

FIG. 6D shows a circular pattern 308 that may be etched on to the elongated polygon transducer membrane 160, or that may be molded or coupled to the elongated polygon transducer membrane 160. FIG. 6D shows that the circular pattern 308 may be disposed in a vertical direction on the elongated polygon transducer membrane 160. Alternatively, the polygon pattern 308 may be alternatively disposed in a horizontal direction on the elongated polygon transducer membrane 160.

FIG. 6E shows an oval pattern 310 that may be etched on to the elongated polygon transducer membrane 160, or that may be molded or coupled to the elongated polygon transducer membrane 160. FIG. 6E shows that the oval pattern 310 may be disposed in a vertical direction on the elongated polygon transducer membrane 160. Alternatively, the polygon pattern 308 may be alternatively disposed in a horizontal direction on the elongated polygon transducer membrane 160.

FIG. 6F shows a concentric circle pattern 312 that may be etched on to the elongated polygon transducer membrane 160, or that may be molded or coupled to the elongated polygon transducer membrane 160. In some implementations, concentric lines 314 may be added to the concentric circle pattern to have a ribbed structure form a pattern in the shape of a spider web, such as shown in FIG. 6G. FIG. 6H shows a honeycomb pattern that may be formed from hexagonal ribs 316 according to an implementation of the disclosed subject matter.

Adjusting the rigidity of the elongated polygon transducer membrane 160, such as with the ribs or patterns shown in FIGS. 6A-6H (as well as shown in FIGS. 7-8G and disclosed below) may at least partially acoustically match the operating medium (e.g., air) and the transducer 150, as well as to assist the transducer 150 in increasing the signal-to-noise ratio so that the transducer 150 may generate a useable signal even from received low-amplitude signals, to increase electroacoustic energy conversion efficiency.

FIG. 7 shows an example of radial members 316 extending from a center pattern 314 disposed on a surface of the elongated polygon transducer membrane 160 according to an implementation of the disclosed subject matter. The radial members 316 and the center pattern 314 may be formed through any suitable additive or subtractive processes. The radial members 316 and the center pattern 314 may be etched into the elongated polygon transducer membrane 160. In some implementations, the radial members 316 and the center pattern 314 may be molded or coupled to the elongated polygon transducer membrane 160. The radial members 316 and the center pattern 314 may be bonded, welded, soldered, fixed (e.g., with an adhesive), or coupled in any suitable manner to the elongated polygon transducer membrane 160. In some implementations, the radial members 316 and the center pattern 314 may be integrally formed with the elongated polygon transducer membrane 160 through any suitable additive or subtractive processes. The radial members 316 and the center pattern 314 may have a thickness, profile, structure, and/or placement so as to increase the rigidity of the elongated polygon transducer membrane 160. The radial members 316 may be selected and arranged to at least partially acoustically match the operating medium (e.g., air) and the transducer 150, as well as to assist the transducer 150 in increasing the signal-to-noise ratio so that the transducer 150 may generate a useable signal even from received low-amplitude signals.

The radial members 316 and the center pattern 314 may be disposed on the surface of the elongated polygon transducer membrane 160 so as to be staggered, where each shape of the radial members 316 and the center pattern 314 is spaced a predetermined distance away from the adjacent shape of the radial members 316 and the center pattern 314.

FIGS. 8A-8G show example cross-sectional views of rib profiles disposed on an elongated polygon transducer membrane according to implementations of the disclosed subject matter. The elongated polygon transducer membrane 160 may include at least one rib disposed longitudinally or horizontally between the edges 161, where the at least one rib may be a rectangular rib, an oval rib, a trapezoidal rib, a tubular rib, a C-shaped rib, a D-shaped rib, and a V-shaped rib. The cross sectional rib profiles may be used for ribs shown in FIGS. 6A-6H and/or the radial members shown in FIG. 7. The different rib profiles shown in FIGS. 8A-8G may add different levels of structural rigidity to the elongated polygon transducer membrane 160. That is, the rib profile may be selected based on the desired structural rigidity for the elongated polygon transducer membrane 160. The rib profiles may selected and arranged to at least partially acoustically match the operating medium (e.g., air) and the transducer 150, as well as to assist the transducer 150 in increasing the signal-to-noise ratio so that the transducer 150 may generate a useable signal even from received low-amplitude signals.

FIG. 8A shows a rectangular rib profile 400, FIG. 8B shows an oval rib profile 402, FIG. 8C shows a C-shaped rib profile 404, and FIG. 8D shows a D-shaped rib profile 406. FIG. 8E shows a V-shaped rib profile 408, FIG. 8F shows a trapezoid shaped rim profile 410, and FIG. 8G shows a tubular shaped rib profile 412. The rib profiles shown in FIGS. 8A-8G may be formed through any suitable additive or subtractive processes, and may increase the structural rigidity of the elongated polygon transducer membrane 160. In some implementations, the type of rib profile selected may increase the rigidity of the elongated polygon transducer membrane more than another type of rib profile.

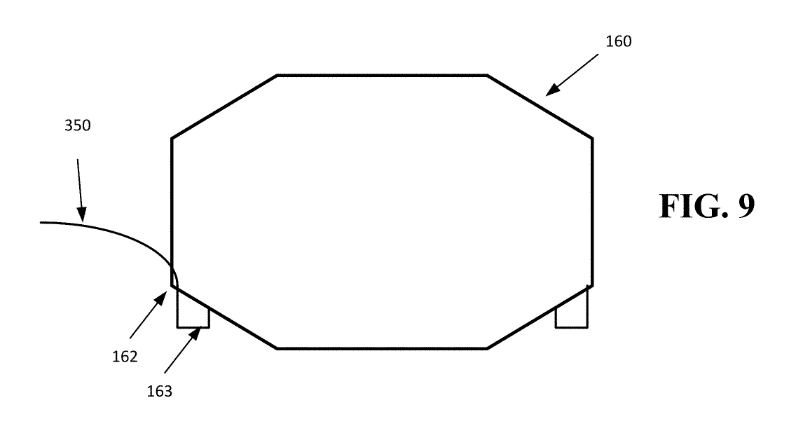

FIG. 9 shows an electrically conductive member 350 coupled to one of the vertices 162 of the elongated hexagon transducer membrane 160 according to an implementation of the disclosed subject matter. The electrically conductive member 350 may be coupled to at least one of the plurality of vertices 162 at which the elongated hexagon transducer membrane 160 is fixed to the support structure at attachment points 163. The electrically conductive member 350 may be used at least in part so the elongated polygon-shaped electrically active material layer 170 and/or elongated hexagon transducer membrane 160 may transform electrical excitation into a high-frequency vibration to produce ultrasonic acoustic emissions.

FIG. 10 shows an example transducer array according to an implementation of the disclosed subject matter. An electromechanical transducer array may include any number of ultrasonic transducers. The ultrasonic transducers may share a common piece of material as a substrate, or may use any suitable number of separate pieces of material, for example, with each ultrasonic transducer having its own separate piece of substrate material. The ultrasonic transducers of an electromechanical transducer array may be divided into cells. Each cell may include a single ultrasonic transducer covered by a membrane or membrane section, or may include multiple ultrasonic transducers. The cells of may be any suitable shape, in any suitable pattern. Cells may be any suitable polygon, and may be arranged in any suitable pattern. For example, as shown in FIG. 10, the transducer array 10 may include a plurality of the apparatus 100 shown in FIGS. 1A-2B and disclosed above that include ultrasonic transducers. The ultrasonic transducers may be arranged in any suitable manner, such as, for example, in a grid pattern.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. An apparatus comprising:
an elongated polygon transducer membrane having a perimeter comprising a plurality of edges and a plurality of vertices, the elongated polygon transducer membrane fixed to a support structure at or around a plurality of the vertices and not fixed to the support structure at more than 50% of the perimeter.

2. The apparatus of claim 1, wherein the elongated polygon transducer membrane is formed of at least one from the group consisting of: aluminum, monocrystalline silicon, amorphous silicon, brass, Invar, titanium, nickel, steel, iron, magnesium, and copper.

3. The apparatus of claim 2, wherein the elongated polygon transducer membrane has a first surface and a second surface and is coated on at least one of the first surface and the second surface with an electrically conductive material.

4. The apparatus of claim 3, wherein the electrically conductive material is selected from the group consisting of: gold, copper, and aluminum.

5. The apparatus of claim 1, wherein the elongated polygon transducer membrane has an aspect ratio in a range of 1.03:1-2:1.

6. The apparatus of claim 1, wherein the elongated polygon transducer membrane is elongated such that has at least two of the edges have a greater length than that of the other edges of the plurality of edges.

7. The apparatus of claim 1, wherein elongated polygon transducer membrane includes at least one rib or pattern disposed on a surface of the elongated polygon transducer membrane.

8. The apparatus of claim 7, wherein the at least one rib or pattern is etched into the elongated polygon transducer membrane.

9. The apparatus of claim 7, wherein the at least one rib or pattern is molded or coupled to the elongated polygon transducer membrane.

10. The apparatus of claim 7, wherein the pattern is selected from the group consisting of: a rectangular pattern, a hexagonal pattern, a polygon pattern, a circular pattern, an oval pattern, and a concentric circle pattern.

11. The apparatus of claim 10, wherein the pattern includes a radial member which extends from the center of the pattern.

12. The apparatus of claim 7, wherein the pattern is disposed on the surface of the elongated polygon transducer membrane so as to be staggered, wherein each shape in the pattern is spaced a predetermined distance away from the adjacent shape in the pattern.

13. The apparatus of claim 1, further comprising:
an electrically conductive member coupled to at least one of the plurality of vertices at which the elongated hexagon transducer membrane is fixed to the support structure.

14. An apparatus comprising:
an elongated hexagon transducer membrane having a perimeter comprising six edges and six vertices, the elongated hexagon transducer membrane fixed to a support structure at or around two vertices of the six vertices that are most distant from each other and not fixed at the other vertices or the edges of the perimeter.

15. The apparatus of claim 14, further comprising:
an electrically conductive member coupled to at least one of the two vertices of the six vertices at which the elongated hexagon transducer membrane is fixed to the support structure.

16. The apparatus of claim 14, wherein the elongated hexagon transducer membrane is formed of at least one from the group consisting of: aluminum, monocrystalline silicon, amorphous silicon, brass, Invar, titanium, nickel, steel, iron, magnesium, and copper.

17. The apparatus of claim 16, wherein the elongated hexagon transducer membrane has a first surface and second surface and is coated on at least one of the first surface and the second surface with an electrically conductive material.

18. The apparatus of claim 17, wherein the electrically conductive material is selected from the group consisting of: gold, copper, and aluminum.

19. The apparatus of claim 14, wherein the elongated hexagon transducer membrane has an aspect ratio in a range of 1.03:1-2:1.

20. The apparatus of claim 14, wherein the elongated hexagon transducer membrane is elongated such that has at least two of the edges have a greater length than that of the other edges.

21. The apparatus of claim 14, wherein elongated hexagon transducer membrane includes at least one rib or pattern disposed on a surface of the elongated hexagon transducer membrane.

22. The apparatus of claim 21, wherein the at least one rib or pattern is etched into the elongated hexagon transducer membrane.

23. The apparatus of claim 21, wherein the at least one rib or pattern is molded or coupled to the elongated hexagon transducer membrane.

24. The apparatus of claim 21, wherein the pattern is selected from the group consisting of: a rectangular pattern, a hexagonal pattern, a polygon pattern, a circular pattern, an oval pattern, and a concentric circle pattern.

25. The apparatus of claim 24, wherein the pattern includes a radial member which extends from the center of the pattern.

26. The apparatus of claim 24, wherein the pattern is disposed on the surface of the elongated hexagon transducer membrane so as to be staggered, wherein each shape in the pattern is spaced a predetermined distance away from the adjacent shape in the pattern.
